(19) United States
(12) Patent Application Publication
(10) Pub. No.: US 2014/0025676 A1
(43) Pub. Date: Jan. 23, 2014

(54) SYSTEM AND METHOD FOR PROCESSING PRE-AUTHORIZED CONTACT DATA

(71) Applicant: James Alexander, Mount Kisco, NY (US)

(72) Inventor: James Alexander, Mount Kisco, NY (US)

(73) Assignee: Vizibility Inc., New York, NY (US)

(21) Appl. No.: 13/555,594

(22) Filed: Jul. 23, 2012

(51) Int. Cl. G06F 17/30

(52) U.S. Cl. 707/736; 707/E17.093

(57) ABSTRACT

Disclosed are systems, methods, and non-transitory computer-readable storage media for processing pre-authorized contact data. An exemplary computer-implemented method includes receiving contact data by a computing device based at least in part upon accessing a machine-readable code, wherein the machine-readable code encodes a network address for accessing the contact data. The method can also include automatically associating at least one of current location, current date, or current time information with the received contact data. Moreover, the method can optionally include associating one or more notes with the received contact data, wherein the one or more notes are capable of providing information relating to the received contact data. The method can further include generating an electronic contact entry based at least in part upon the received contact data, at least one of the associated current location, current date, or current time information, and optionally upon the one or more notes.

### BACKGROUND

1. Technical Field

The present disclosure relates to enabling access to pre-authorized contact data to generate electronic contact entries.

2. Introduction

Often individuals meet at a networking or other event and share business cards, resumes, or other contact information. After meeting people, an individual may forget who he/she met at the networking or other event. Even when the individual looks at the business cards, resumes, or other contact information received from other individuals, the former may not be able to attach a face or personality to the received business cards, resumes, or other contact information. Conventionally, users can attempt to write a note, for example, on the back of each business card, resume, or other contact information received, to help them remember the person associated with each respective business card, resume, or other contact information. However, users might not have a pen, pencil, or other instrument (including a computing device) handy to write the note. A user who has a computing device handy can attempt to write a note on the spot, but the device battery may be dead or the device may not function correctly at the time. Moreover, even if the user can write a note, social protocol may prohibit or look down on lengthy interactions with a computing device, such as mobile phone or tablet, during the networking or other event. Accordingly, what is needed in the art is a way to improve the handling of contact information.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for accessing pre-authorized contact data. An exemplary computer-implemented method includes receiving contact data by a computing device based at least in part upon accessing a machine-readable code, wherein the machine-readable code encodes a network address for accessing the contact data. For example, the machine-readable code can be a QR code, a Microsoft TAG, a matrix bar code, a wireless near-field communication signal, a RFID signal, a Bluetooth signal, a short-range wireless signal, a uniquely identifiable image, or a uniquely identifiable biometric code. The method can also include automatically associating at least one of current location, current date, or current time information with the received contact data. Moreover, the method can optionally include associating one or more notes with the received contact data, wherein the one or more notes are capable of providing information relating to the received contact data. The method can further include generating an electronic contact entry based at least in part upon the received contact data, at least one of the associated current location, current date, or current time information, and (optionally) upon the one or more notes.

In some embodiments, the method can include modifying at least one of the received contact data, the associated current location information, the associated current date information, the associated current time information, or the optional one or more notes (if any) for the electronic contact entry. In some embodiments, the electronic contact entry is at least one of an electronic business card, a vCard, or an entry stored in an address book of the computing device. In some embodiments, the method can include transmitting the generated electronic contact entry to one or more recipients, wherein the transmission is initiated by a user of the computing device and includes information associated with the user. In some embodiments, the method can further include uploading the generated electronic contact entry to at least one server for sharing the contact entry with one or more users of the at least one server. In some embodiments, the method can also include notifying an entity associated with the network address encoded in the machine-readable code in response to the machine-readable code being accessed.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 depicts an example process for using a machine-readable code to access pre-authorized contact data to generate an electronic contact entry;

FIG. 3A illustrates an example GUI for optionally alerting a user that a machine-readable code has been scanned;

FIG. 3B illustrates an example GUI for optionally prompting a user for authorization to use current location information;

FIG. 3C illustrates an example GUI for automatically associating current location, current time, and/or current date information with pre-authorized contact data;

FIG. 3D illustrates an example GUI for optionally associating one or more user notes with pre-authorized contact data;

FIG. 3E illustrates an example GUI showing pre-authorized contact data with associated current location, time, and/or date information and one or more user notes;

FIG. 3F illustrates an example GUI for generating an electronic contact entry based on pre-authorized contact data with associated current location, time, and date information and one or more user notes;

FIG. 4A illustrates an example GUI for processing an electronic contact entry;

FIG. 4B illustrates an example GUI for processing an electronic contact entry;

FIG. 5 illustrates an example GUI for downloading an electronic contact entry;

FIG. 6 illustrates an example GUI for emailing an electronic contact entry;

FIG. 7 illustrates an example GUI for making an introduction using an electronic contact entry;

FIG. 8 illustrates an example GUI for uploading an electronic contact entry; and

FIG. 9 illustrates an example method embodiment for using a machine-readable code to access pre-authorized contact data to generate an electronic contact entry.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

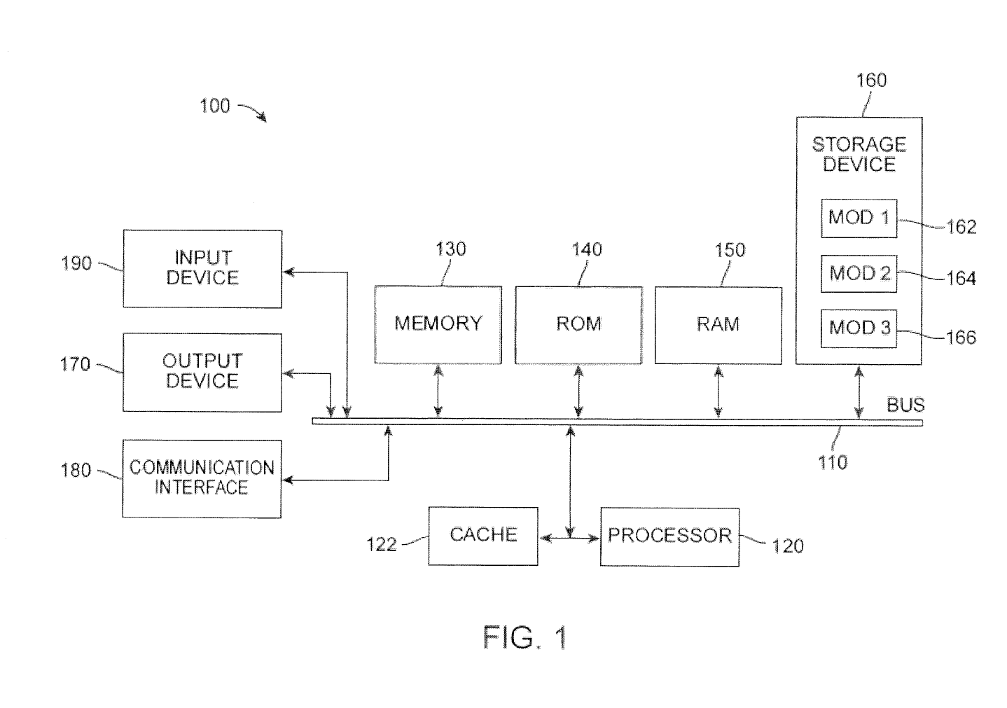

The present disclosure addresses the need in the art for enhancing calendar scheduling. A brief introductory description of a basic general purpose system or computing device in FIG. 1 which can be employed to practice the concepts is disclosed herein. A more detailed description of the exemplary approaches and sample infrastructure will then follow. These variations shall be discussed herein as the various embodiments are set forth. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

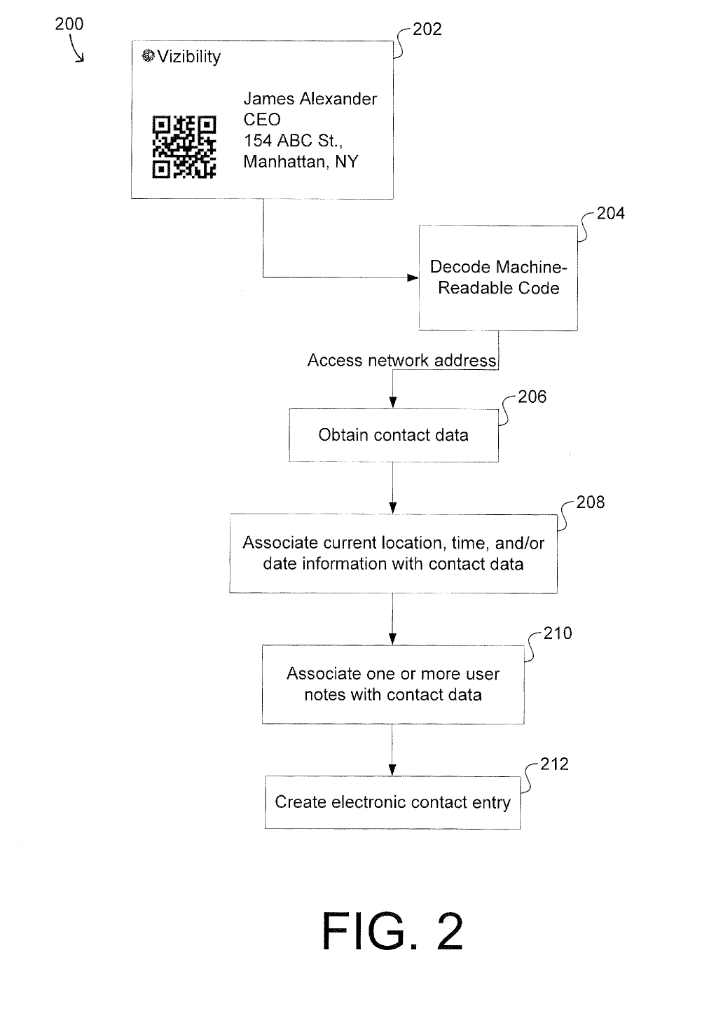

FIG. 2 depicts an example process 200 for using a machine-readable code to access pre-authorized contact data to generate an electronic contact entry. The example process 200 can comprise decoding a machine-readable code 204, such as a QR code on a business card 202. For example, a user (“User A”) can meet at least one other user (“User B”) at an event, such as a networking event, a party, or just walking on the street. User A and User B can decide to exchange contact information/data. User B can give his/her business card 202 to User A. The business card 202 can include a machine-readable code, such as a QR code. User A can scan (e.g., using his/her computing device) the QR code on User B's business card to decode the machine-readable code.

Continuing with the example, the machine-readable code can encode a network address, such as a uniform resource locator (URL) or a hyperlink. Once decoded, the QR code providing the network address can link to User B's contact information/data, which can be stored on a networking service/website (e.g., Vizibility.com). In some embodiments, User B's contact data has already been previously entered by User B (e.g., User B previously set up his/her Vizibility.com account and inputted his/her contact data). At least in some embodiments, User B is pre-authorizing anyone who has the network address to access User B's contact data. In other words, User B's contact data that is linked to the network address has already been authorized by User B for anyone to access as long as that person has the network address. As such, when User B gives to User A the business card 202 with the network address encoded in the QR code, User B is granting User A access to User B's pre-authorized contact data.

Continuing with the example process, at step 206, User B's pre-authorized contact data can be obtained via the network address in the QR code. In some embodiments, User A can use his/her computing device to obtain the contact data. For example, a service associated with the network address (e.g., a Vizibility.com server) can provide the contact data to be received on the computing device). The contact data can comprise information such as User B's name, profile picture, address, email, phone number, instant message screen-name, job title, company, etc.

At step 208, current location, current time, and/or current date information can be associated with the obtained/received contact information. In some embodiments, the current location, time, and/or date information can be determined by the computing device and transmitted to the service (e.g., the Vizibility.com server); the service can then associate the current location/time/date information with the contact data.

To determine the current location, current time, and/or current data information, the computing device of User A can, for example, check its system settings. In some embodiments, the computing device can prompt User A for authorization to use the current location/time/date information and associate that information with the contact data. In some embodiments, at least one of the current location, current time, or current date can be automatically determined and become associated with the obtained contact data of User B without needing to prompt User A.

At step 210, one or more user notes can optionally be associated with the obtained contact data of User B. In some embodiments, the one or more user notes can be one or more notes written by User A. In some embodiments, the one or more notes can be written via the computing device and then transmitted to the service/Vizibility server, which then associates the one or more notes with the contact data.

The one or more notes can provide information related to the contact data. User A can write a note to help remind himself/herself of who User B is and/or how User A met User B, such that it can be easier later on for User A to remember who User B is. For example, User A can write a note such as “met at Michael Jackson concert,” “has a pet rabbit,” “is the CEO of Vizibility®,” etc. In some embodiments, the note can be media data, such as an image, video, audio, etc. For example, User A record an audio clip to remind himself/herself of who User B is and/or how they met.

The example process further comprises, at step 212, creating at least one electronic contact entry, such as a vCard or a contact entry in an electronic address book. In some embodiments, the service/Vizibility.com server can create an electronic contact entry based at least in part upon the contact data, at least one of the associated current location, current date, or current time information, and optionally the one or more user notes. For example, the service/Vizibility server can create a vCard for User B which includes User B's pre-authorized contact data (obtained/received via the network address), the current location (e.g., where User A and User B met, where the computing device is when the QR code was scanned, etc.), the current time/date (e.g., when User A and User B met, when the computing device performed the scanning of the QR code, etc.), and the one or more notes (if any) made by User A.

In some embodiments, additionally or alternatively to the service (e.g., one or more Vizibility® server(s)), the computing device of User A can associate the current location/time/date and/or notes with the contact data and create the electronic contact entry. For example, the computing device of User A can execute an application corresponding to the service (e.g., a Vizibility® mobile app) to facilitate with performing the above steps.

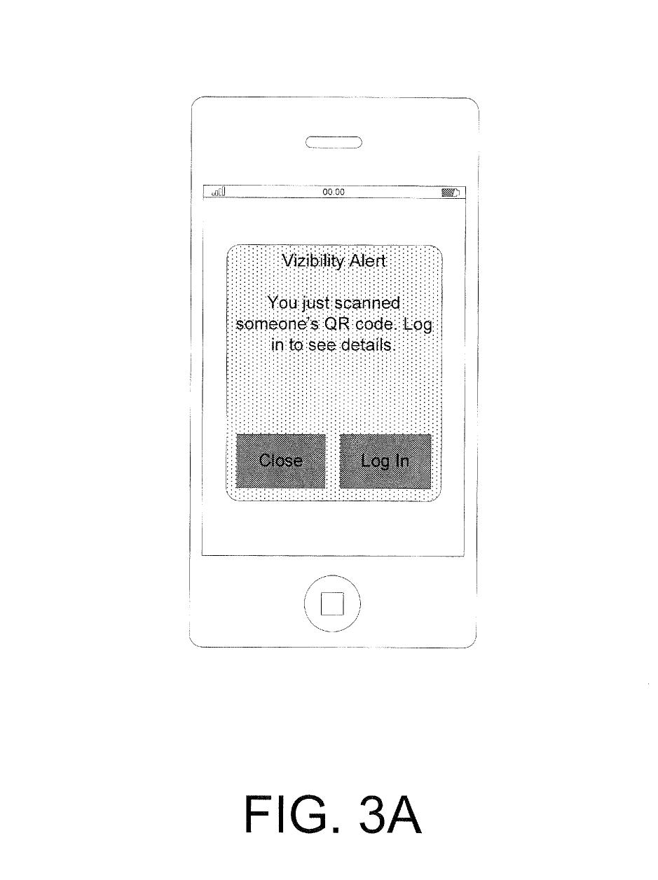

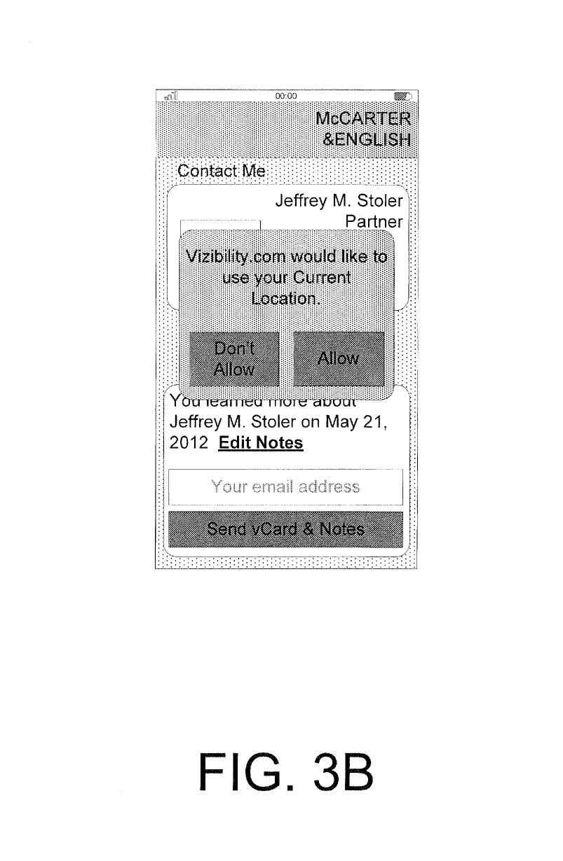

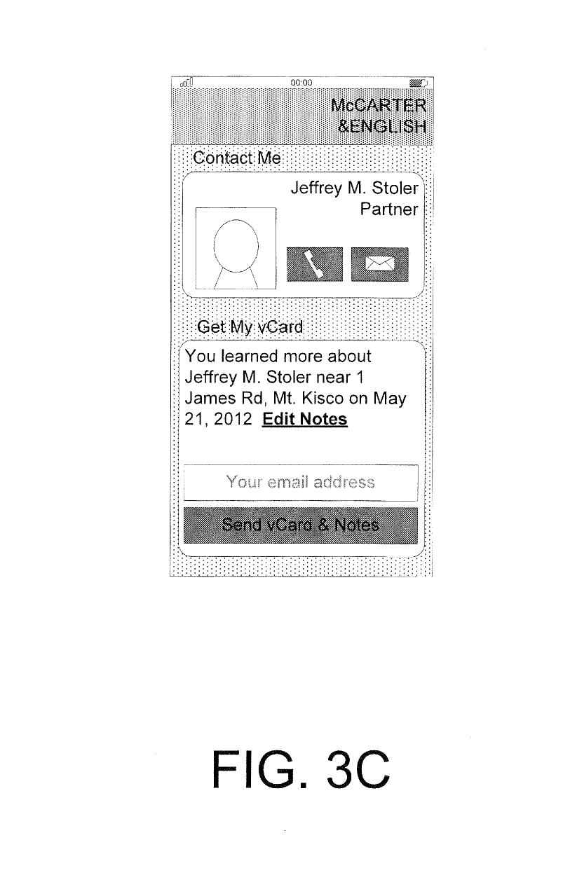

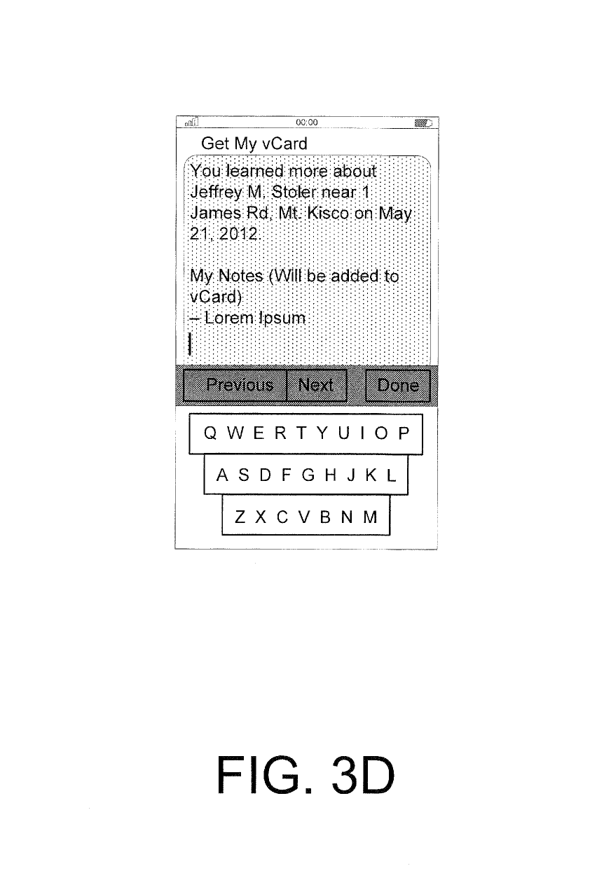

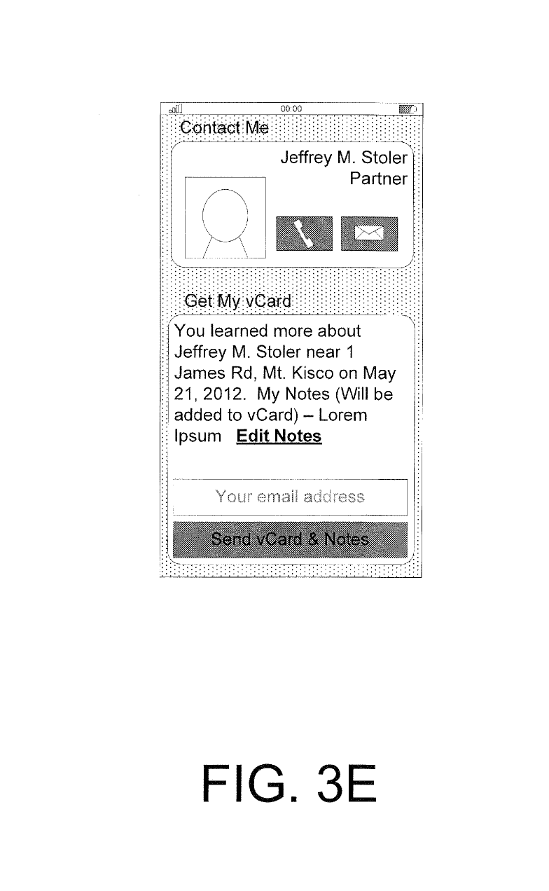

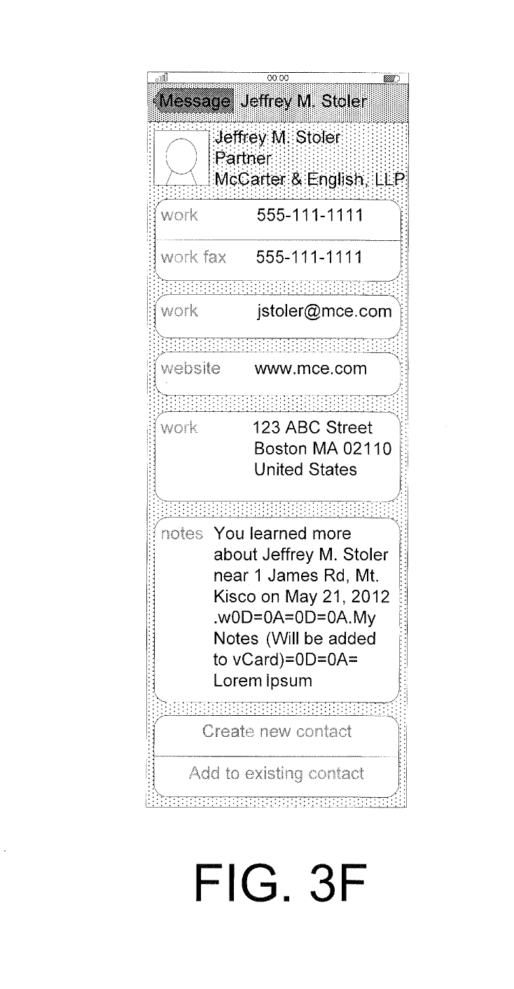

Referring now to FIG. 3A through 3F, example graphical user interfaces (GUI's) that can be presented on a display screen of a computing device are illustrated. FIG. 3A illustrates an example GUI in which a user is optionally alerted that a machine-readable code has been scanned. For example, when a user of a computing device scans a machine-readable code such as a QR code on a business card, an alert can appear on the display screen of the computing device. The alert can inform and/or confirm to the user that the QR code was successfully scanned. In some embodiments, the alert can provide buttons and/or other input for the user to select. For example, the user can close the alert, such as if the scan was accidental/erroneous, or the user can proceed to view more details associated with the scanned code (e.g., log in to Vizibility®, obtain/receive (pre-authorized) contact data associated with an owner of the business card, etc.).

In some embodiments, the optional alert is not necessary. For example, when the computing device scans the machine-readable code, an action in response to the scan (e.g., opening an application on the computing device, going to a web address using a web browser on the computing device, etc.) can automatically occur. Accordingly, in some embodiments, when the machine-readable code is scanned (and decoded), the computing device can proceed with respect to the network address without alerting the user (e.g., logging into a web site at the network address to obtain contact data, automatically receiving contact data via the network address, etc.).

In some embodiments, an entity associated with the network address encoded in the machine-readable code (and/or associated with the contact data linked to the network address) can optionally be notified or alerted in response to the machine-readable code being accessed. For example, the entity (e.g., person, group of corporate representatives, etc.) that provides the business card with the QR code can be alerted/notified when the QR code is scanned. In some embodiments, the alert/notification can inform the entity of who (and/or when, where, etc.) scanned the QR code. For example, the entity's computing device can receive an alert/notification that the user has scanned the QR code using the user's computing device.

Turning now to FIG. 3B, an example GUI for optionally prompting the user for authorization to use current location information is illustrated. In some embodiments, there can be an optional prompt asking the user whether current location information can be used. In some embodiments, the optional prompt is not necessary. For example, the user (or default settings of the device) can configure the computing device to automatically utilize current location information whenever possible.

The current location information can refer to an estimated/calculated location of where the computing device is. In some embodiments, this location can correspond to where the user is, where the scanning of the business card takes place, and/or where the user meets the owner of the business card, etc. The current location can be determined by the computing device by utilizing, for example, global positioning system (GPS), cellular triangulation, WiFi location, IP address location, and/or other location determining technologies.

In some embodiments, a service associated with the network address (e.g., a Vizibility® server, the computing device running a Vizibility(s) app, etc.) can associate the current location information with contact data received (e.g., obtained) via the machine-readable code. For example, when the current location information has been determined by the computing device, the device can transmit that information to the service which the associates the information with the contact data. As shown in the example GUI of FIG. 3C, the contact data of the entity associated with the code (e.g., the owner of the business card, Jeffrey M. Stoler) can be associated with the current location information (e.g., near 1 James Rd, Mt. Kisco).

Additionally or alternatively to current location information, information about the current time and/or current date can also be associated with the contact data. FIG. 3C illustrates an example GUI for automatically associating current location, current time, and current date information with pre-authorized contact data. For example, the current date (e.g., May 21, 2012) can also be associated with the contact data (e.g., for Jeffrey M. Stoler) along with the current location. In some embodiments, the current time and/or date information can be determined by the computing device and transmitted to the service; the service (or computing device running an application corresponding to the service) then associates the current time/date information with the contact data.

In some embodiments, there can also be an option for the user to input one or more notes. The one or more notes can be used to help the user remember meeting the entity that provided the code (e.g., Jeffrey M. Stoler). The one or more notes can be text or media files. As shown in FIG. 3C, the user can select “Edit Notes” to add one or more notes. If the user chooses to add a note, the service associated with the network address (or computing device with an application for the service for example) can associate the note with the contact data (along with the current location/time/date).

FIG. 3D illustrates an example GUI for optionally associating one or more user notes with pre-authorized contact data. As shown in FIG. 3D, the user can optionally, for example, type text (e.g., Lorem Ipsum) to be saved as a note associated with the contact data for Jeffrey M. Stoler, along with where and when the scanning of the code took place (and presumably where and when the meeting occurred as well). In some embodiments, there can be buttons, keys, and other inputs (e.g., keyboard) for the user to enter the one or more notes. In some embodiments, the user can use a camera and/or a microphone on the computing device to record one or more images, videos, and/or audios to be saved as one or more notes associated with the contact data.

FIG. 3E illustrates an example GUI showing pre-authorized contact data with associated current location, time, and date information and one or more user notes. In FIG. 3E, the contact data and associated current location/time/date information and notes are ready to be used to generate an electronic contact entry. In some embodiments, the user can input his/her email address to which the generated electronic contract entry will be sent. For example, although the contact data and associated information/notes are presented on the display screen of the computing screen, they might still be stored on the service (e.g., Vizibility.com server); as such, the service can generate the electronic contact entry and transmit (e.g., via email, SMS, etc.) it to (the computing device of) the user.

FIG. 3F illustrates an example GUI for generating an electronic contact entry based on pre-authorized contact data with associated current location, time, and date information and one or more user notes. The example GUI of FIG. 3F shows an electronic contact entry generated based at least in part upon the contact data and associated current location/time/date information and user notes if any. The electronic contact entry can be an electronic business card, a vCard, an entry in an electronic address book, etc. In some embodiments, the electronic contact entry can be accessed from an email, SMS text, etc., message. For example, when the service generates the electronic contact entry (e.g., a vCard), the electronic contact entry can be emailed to the user to be downloaded and stored as an entry in an address book of his/her computing device.

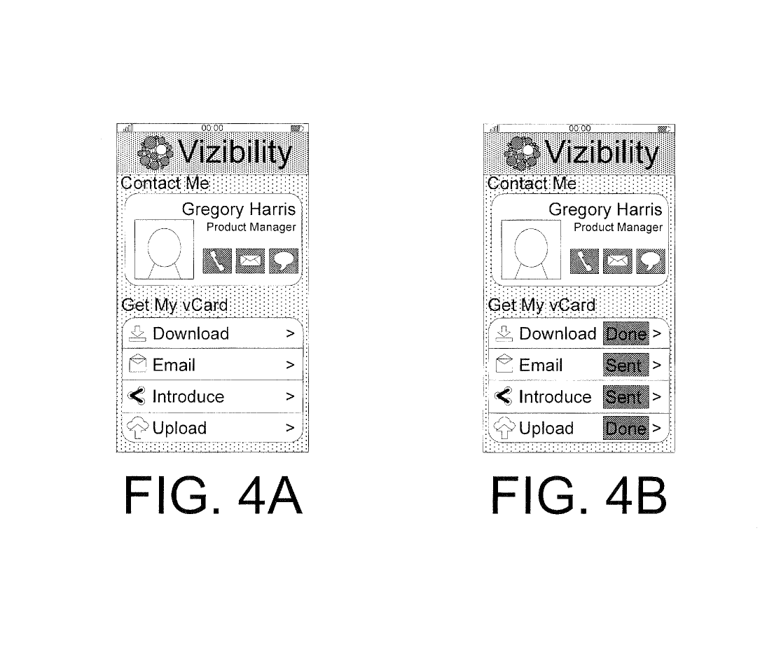

With reference now to FIG. 4A and FIG. 4B, example GUIs for processing an electronic contact entry are shown. FIG. 4A illustrates an example GUI for further processing an electronic contact entry. In some embodiments, the electronic contact entry can be downloaded (e.g., from the networking service/Vizibility® server), emailed to oneself and/or others, used to make an introduction involving a third party, and/or uploaded (e.g., to a social/professional networking service, website, organization, company, etc.).

For example, a user of a computing device can have a vCard (e.g., generated according to various embodiments of the present disclosure) in the inbox of an email application on the computing device. The vCard can provide the user with the option to download the vCard (e.g., and save it as an entry in an address book on the computing device). The user can also email the vCard to one or more recipients. In addition, the user can introduce the entity associated with the (network address and/or) contact data (e.g., Gregory Harris) to a third party. For example, the third party can also have an account with the networking service (e.g., a Vizibility.com account) and/or an application corresponding to the service (e.g., a Vizilbity® app). As such, the introduction can be made via the service/application. Furthermore, the user can upload the vCard, for example, to a social/professional networking service, website, organization, company, etc.

FIG. 4B illustrates a different version of the example GUI in FIG. 4A. In FIG. 4B, there can be indications for showing statuses of each further processing. For example, as shown in FIG. 4B, the downloading can be indicated as already done, the email can be indicated as already sent, the introduction can be indicated as sent, and the uploading can be indicated as done as well.

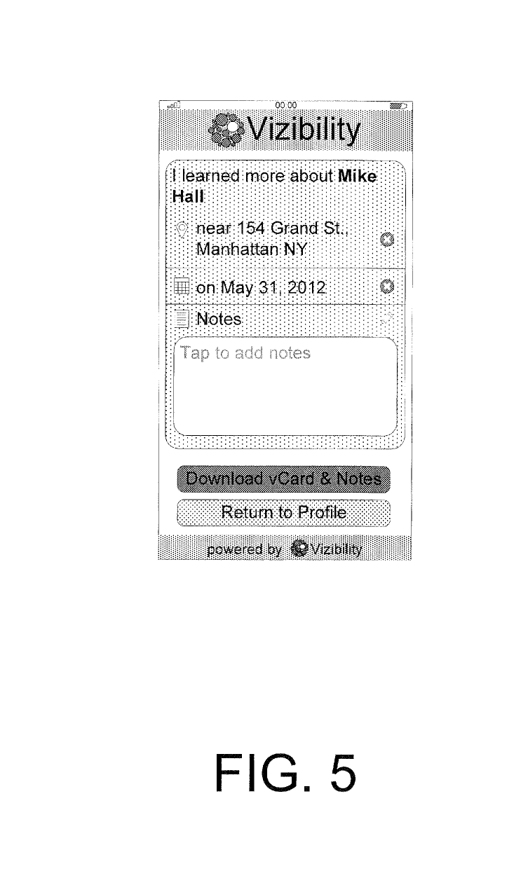

FIG. 5 illustrates an example GUI for downloading an electronic contact entry. In FIG. 5, the user might have just met someone (e.g., Mike Hall). The vCard for Mike Hall can be generated by the networking service (e.g., Vizibility®). In some embodiments, the vCard can be downloaded from the networking service, as shown in FIG. 5. For example, the vCard can be downloaded from the service as an entry in an address book of the user's computing device.

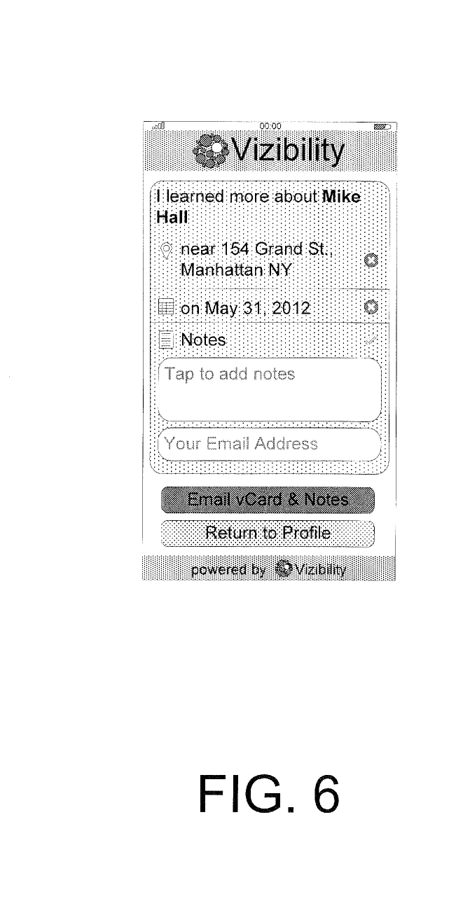

FIG. 6 illustrates an example GUI for emailing an electronic contact entry. Continuing with the previous example, the user might have just met Mike Hall. The vCard for Mike Hall can be generated by the networking service (e.g., Vizibility®). In some embodiments, the vCard can be emailed from the networking service, as shown in FIG. 5. For example, the vCard can be emailed from the service to one or more email addresses of the user and/or third parties. In some embodiments, the vCard can be downloaded from the email.

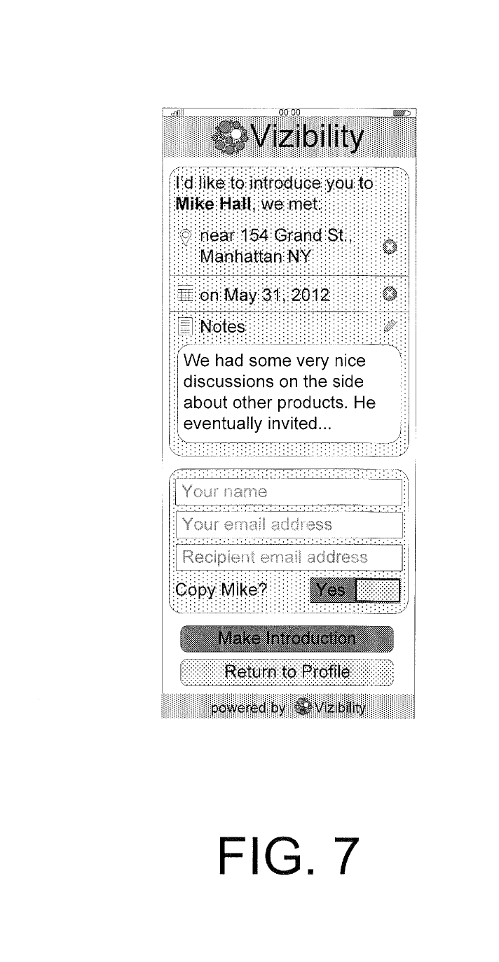

FIG. 7 illustrates an example GUI for making an introduction using an electronic contact entry. For example, the user might want to introduce Mike Hall to a third party. The introduction can include a note/message from the user to comment on the introduction (e.g., “We had some very nice discussions on the side about other products. He eventually invited . . . ”). The user can input his/her name and email address, the third party's email address, and can copy Mike Hall. In some embodiments, all three (or more) parties can have accounts with the networking service, such that the introduction can occur via the service (which can be more efficient and/or convenient than doing so via email, SMS text, etc.).

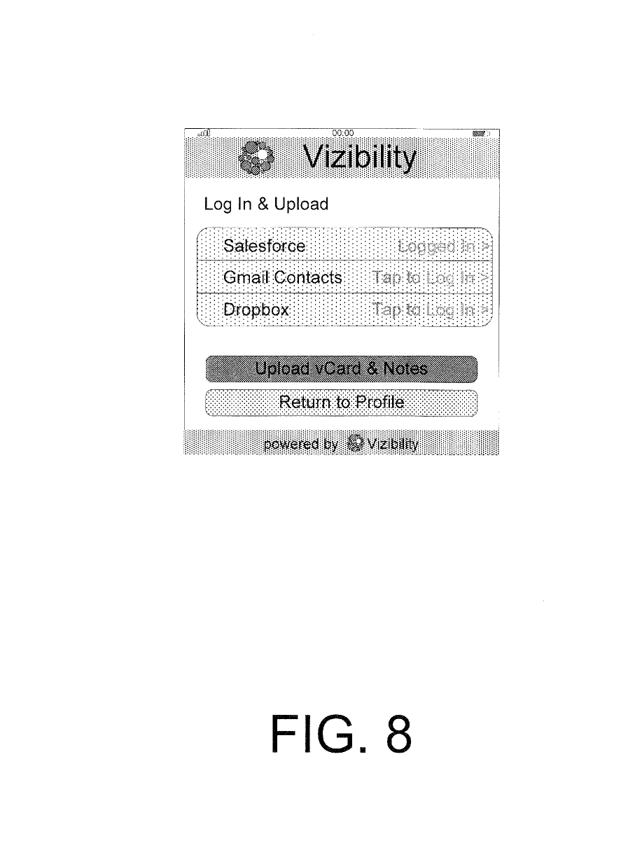

FIG. 8 illustrates an example GUI for uploading an electronic contact entry. In some embodiments, the user can upload one or more vCards (e.g., including his/her own) to a server external to the user's computing device. For example, the user can upload a vCard to Salesforce.com Dropbox®, Gmail Contacts®, Google Plus®, Linkedin®, Facebook®, Twitter®, etc. In some embodiments, the vCard (electronic contact entry) can be shared with one or more users of the server (e.g., one or more members of a social network, company, organization, etc.). For example, the user can upload his/her own vCard to increase the likelihood for career opportunities. In another example, the user can upload another person's vCard to a server/network/organization and recommend that person to users of the server/network/organization.

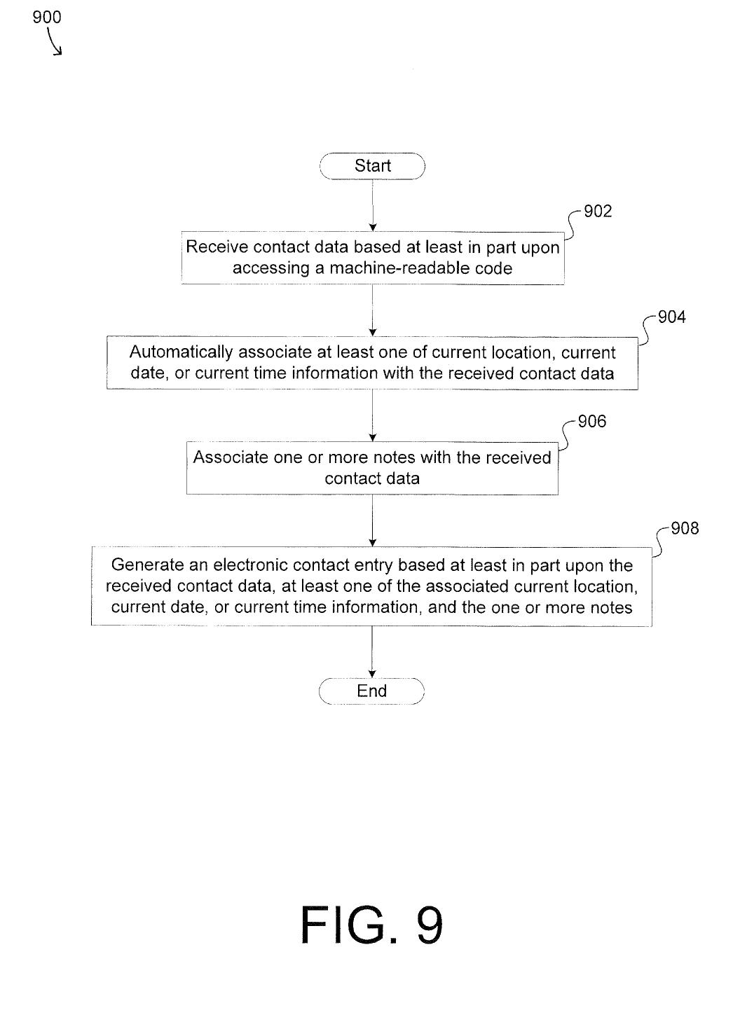

FIG. 9 illustrates an example method embodiment 900 for using a machine-readable code to access pre-authorized contact data to generate an electronic contact entry. It should be understood that there can be additional, fewer, or alternative steps performed in similar or alternative orders, or in parallel, within the scope of the various embodiments unless otherwise stated. The example method embodiment 900 comprises receiving contact data by a computing device based at least in part upon accessing a machine-readable code, wherein the machine-readable code encodes a network address for accessing the contact data, at step 902. At step 904, the example method 900 can automatically associate at least one of current location, current date, or current time information with the received contact data. Step 906 involves optionally associating one or more notes (if any) with the received contact data, wherein the one or more notes are capable of providing information relating to the received contact data. At step 908, the example method 900 generates an electronic contact entry based at least in part upon the received contact data, at least one of the associated current location, current date, or current time information, and the optional one or more notes.

The disclosure now turns to exemplary method embodiments discussed in terms of an exemplary system 100 as shown in FIG. 1 configured to practice the method(s). The steps outlined herein are exemplary and can be implemented in any combination thereof, including combinations that exclude, add, or modify certain steps.

In one embodiment, the system 100 receives contact data based at least in part upon accessing a machine-readable code, wherein the machine-readable code encodes a network address for accessing the contact data. In one example, the machine-readable code is a QR code, a Microsoft TAG, a matrix bar code, a wireless near-field communication signal, a RFID signal, a Bluetooth signal, a short-range wireless signal, a uniquely identifiable image, or a uniquely identifiable biometric code. The system 100 can then automatically associate at least one of current location, current date, or current time information with the received contact data. The system 100 can then optionally associate one or more notes with the received contact data, wherein the one or more notes are capable of providing information relating to the received contact data. The system 100 can further generate an electronic contact entry based at least in part upon the received contact data, at least one of the associated current location, current date, or current time information, and the one or more notes.

In one example, the system 100 can modify at least one of the received contact data, the associated current location information, the associated current date information, the associated current time information, or the one or more notes for the electronic contact entry. In one example, the electronic contact entry is at least one of an electronic business card, a vCard, or an entry stored in an electronic address book. In one example, the system 100 can transmit the generated electronic contact entry to one or more recipients, wherein the transmission is initiated by a user of the computing device and includes information associated with the user. In one example, the system 100 can further upload the generated electronic contact entry to at least one server for sharing the contact entry with one or more users of the at least one server. In one example, the system 100 can also notify an entity associated with the network address encoded in the machine-readable code in response to the machine-readable code being accessed.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

1. A computer-implemented method of sending a preauthorized contact entry comprising:
receiving a request for preauthorized contact data associated with a user account from a requesting device, wherein the requesting device sends the request to a network address optically extracted by the requesting device from a machine readable optical code;
automatically associating at least one of current location, current date, and current time with the request;
generating a preauthorized electronic contact entry,
wherein the preauthorized electronic contact entry includes the associated current location, current date, and current time, and wherein the preauthorized electronic contact entry is an electronic business card or vCard; and
transmitting the preauthorized electronic contact entry to the requesting device.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. The computer-implemented method of claim 1, further comprising automatically notifying a device associated with the user account of the request from the requesting device, wherein the notifying the device associated with the user account includes the current location, current date and current time associated with the request.

14. The computer-implemented method of claim 1, wherein the machine readable optical code is a QR code.

15. The computer-implemented method of claim 1, wherein the machine readable optical code is a Microsoft TAG, a matrix bar code, a uniquely identifiable image, or a uniquely identifiable biometric code.

16. The computer-implemented method of claim 13, wherein the generating the preauthorized electronic contact entry further includes adding user input notes received from the requesting device to the electronic entry.

17. The computer-implemented method of claim 1, wherein the requesting device is a mobile device and wherein the request to the network address optically extracted by the requesting device is extracted by capturing an image of the machine readable optical code by the requesting device.

18. A system comprising:
a processor;
a computer readable storage medium storing instructions for controlling the processor to perform steps comprising:
receiving a request for preauthorized contact data associated with a user account from a requesting device, wherein the requesting device sends the request to a network address optically extracted by the requesting device from a machine readable optical code, wherein the requesting device is a mobile device and wherein the request to the network address optically extracted by the requesting device is extracted by capturing an image of the machine readable optical code by the requesting device;
automatically associating at least one of current location, current date, or current time with the request;
generating a preauthorized electronic contact entry, wherein the preauthorized electronic contact entry includes the at least one of the associated current location, current date, or current time, and wherein the preauthorized electronic contact entry is an electronic business card or vCard;
transmitting the preauthorized electronic contact entry to the requesting device and;
automatically notifying by SMS or email a device associated with the user account of the request from the requesting device, wherein the notifying the device associated with the user account includes the at least one of current location, current date or current time associated with the request.
